(19) United States
(12) Patent Application Publication
(10) Pub. No.: US 2013/0336744 A1
(43) Pub. Date: Dec. 19, 2013

(54) THREADED MASONRY FASTENER

(71) Applicant: INFASTECH INTELLECTUAL PROPERTIES PTE. LTD., Singapore (SG)

(72) Inventors: Cheng Siong PHUA, Singapore (SG); Arnold WANG, Tainan City (TW); Senthil Kumaran KOTHANDARAMAN, Tamilnanu (IN)

(73) Assignee: INFASTECH INTELLECTUAL PROPERTIES PTE. LTD., Singapore (SG)

(21) Appl. No.: 13/913,699

(22) Filed: Jun. 10, 2013

(30) Foreign Application Priority Data
Jun. 15, 2012 (SG) 201204532-4

(51) Int. Cl. F16B 25/00

(52) U.S. Cl. CPC F16B 25/0026
USPC 411/387.1

(57) ABSTRACT

A thread forming fastener for use in concrete, masonry, brick, and the like, having a first thread, second thread, and third thread about a shank, the second thread having a major diameter greater than the major diameter of at least one of the first and third threads with grooves on either side of the second thread adapted to accommodate chips of material during fastening, and the second thread having notches in the major diameter of at least one turn adapted to engage at least one of concrete, masonry, and brick, a helical land axially extending between the third thread and adjacent first thread having an outside diameter greater than the minor diameter and less than the major diameter of the first thread and third thread, the axial land width between the third thread and adjacent first thread being at least 25% of the thread pitch.

This application claims under 35 U.S.C. §119(a) priority to and the benefit of Singapore Patent Application No. 201204532-4 filed on Jun. 15, 2012.

### BACKGROUND AND SUMMARY

The present invention relates generally to threaded fasteners for use in masonry, concrete, brick, and the like.

Threaded fasteners such as screws are used in many applications to connect various components to a masonry, brick or concrete structure. Prior masonry fasteners often required threading the fastener into a receiving plug, such that the process for installing the fastener included drilling a hole, inserting the plug into the hole, and then driving the threaded screw into the plug. The receiving plug typically expanded in the hole providing engagement of the fastener to the drilled hole. The installation of the receiving plug slowed installation of the prior masonry fasteners reducing productivity and increasing cost. Additionally, the receiving plug was typically made of a plastic material, which could be stripped out when the threaded screw was over-tightened. The plastic plug also could melt in a fire loosening the metal threaded screw in the drilled hole. There remains a need for a threaded fastener that overcomes these and other disadvantages of the prior art.

Disclosed is a thread forming fastener for use in concrete, masonry, brick, and the like, having a first thread, second thread, and third thread in a helical arrangement about a shank, each thread having substantially the same thread pitch, the second thread having a major diameter greater than the major diameter of at least one of the first and third threads with grooves on either side of the second thread adapted to accommodate chips of material during fastening, and the second thread having notches in the major diameter of at least one turn adapted to engage at least one of concrete, masonry, and brick, a helical land axially extending between the third thread and adjacent first thread having an outside diameter greater than the minor diameter and less than the major diameter of the first thread and third thread, the axial land width between the third thread and adjacent first thread being at least 25% of the thread pitch, and having a pilot end adapted to guide fastener entry.

The major diameter of the second thread may have a shape selected from the group consisting of square shaped, rounded shaped, polygonal shaped, flat shaped, pointed shaped, and may be between 40% and 100% greater than the thread height of at least one of the first and third threads.

In certain embodiments, the major diameter of the first thread and the third thread may be substantially the same. Alternatively, the major diameter of the third thread may be greater than the major diameter of the first thread. The thread height of the first thread and the third thread may be between 45% and 85% of the thread height of the second thread. Alternatively, the thread height of the first thread and the third thread are between 50% and 70% of the thread height of the second thread.

The notches in the second thread may have a shape selected from the group consisting of rectangular, triangular, polygonal, and arcuate. The notches in the second thread may extend a depth into the second thread less than 50% of the thread height. In certain applications, the notches in the second thread may form a series of lobes with the notches between the lobes about the rotational axis, each lobe having a leading portion and a tailing portion, the leading portion and first adjacent notch at a first angle in a range from 50° to 100° from a plane tangent to the lobe adjacent the leading portion, and the tailing portion and second adjacent notch at a second angle in a range from 25° to 50° from a plane tangent to the lobe adjacent the tailing portion, where the first angle is greater than the second angle. In a lobular embodiment, the notches may be positioned to form from 3 to 8 lobes about the diameter of the second thread.

The helical land between the third thread and adjacent first thread may have an axial land width at least 35% of the thread pitch. The helical land may have a diameter greater than a diameter at 40% of the thread height of the first thread. Alternatively, the helical land may have a diameter greater than a diameter at 55% of the thread height of the first thread.

The axial distance between the first thread and the second thread may be substantially the same as the axial distance between the second thread and the third thread.

The threaded fastener may have at least one minor protrusion formed along at least a portion of the helical land between the third thread and adjacent first thread. The minor protrusion may be continuous along the helical land. Alternatively, the minor protrusion may be intermittent along at least a portion of the helical land.

If present, the minor protrusion may have an outer diameter not more than the major diameter of the first thread. Alternatively, the minor protrusion may have an outer diameter not more than the major diameter of the second thread. At least a part of the minor protrusion may have a cross-sectional shape selected from the group consisting of arcuate, rectangular, elliptical, trapezoidal, and triangular. Additionally, a lead side of the minor protrusion may have a normal angle between about 10° and 60°.

Also disclosed is a thread forming fastener for use in concrete, masonry, or the like, having a first thread, second thread, and third thread in a helical arrangement about a shank, each thread having approximately the same thread pitch, the major diameter of the second thread being greater than the major diameter of at least one of the first and third threads.

### BRIEF DESCRIPTION OF THE DRAWINGS

FIG. 1 is a plan view of a threaded fastener of the present disclosure,

FIG. 2 is a detail of the threaded portion of the present fastener taken from Detail 2 in FIG. 1,

FIGS. 3 and 3A are partial details of the threaded portion of the present fastener taken from Detail 3 in FIG. 1,

FIG. 4 is a cross sectional view through the fastener of FIG. 1 adjacent a second thread,

FIGS. 5A-5I are partial detail views showing various alternatives for a notch taken from detail 5A in FIG. 4,

FIG. 6 is an alternative cross sectional view through the fastener of FIG. 1 adjacent a second thread,

FIGS. 7A and 7B illustrate alternative thread cross-sectional shapes taken through a notch in FIG. 5I,

FIG. 8 is a partial plan view of the present thread form with an optional minor protrusion according to the present disclosure,

FIG. 9 is a partial plan view of the thread for of FIG. 8 with an alternative minor protrusion,

FIG. 10 shows partial plan views of alternative minor protrusions of the thread form of FIG. 8, and

FIG. 11 shows a summary of test data for fastener pull-out force from concrete.

### DETAILED DESCRIPTION OF THE DRAWINGS

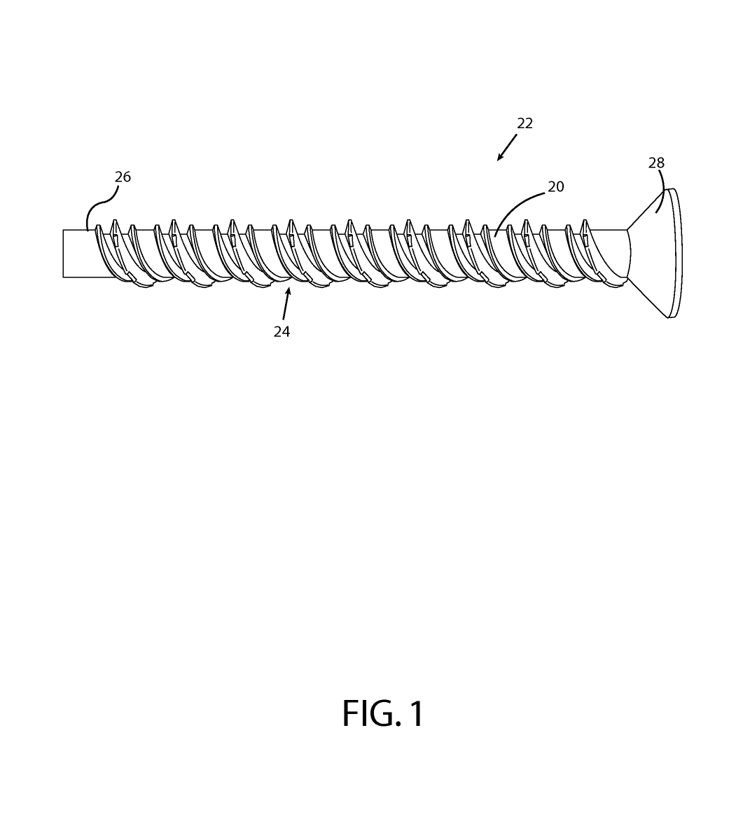

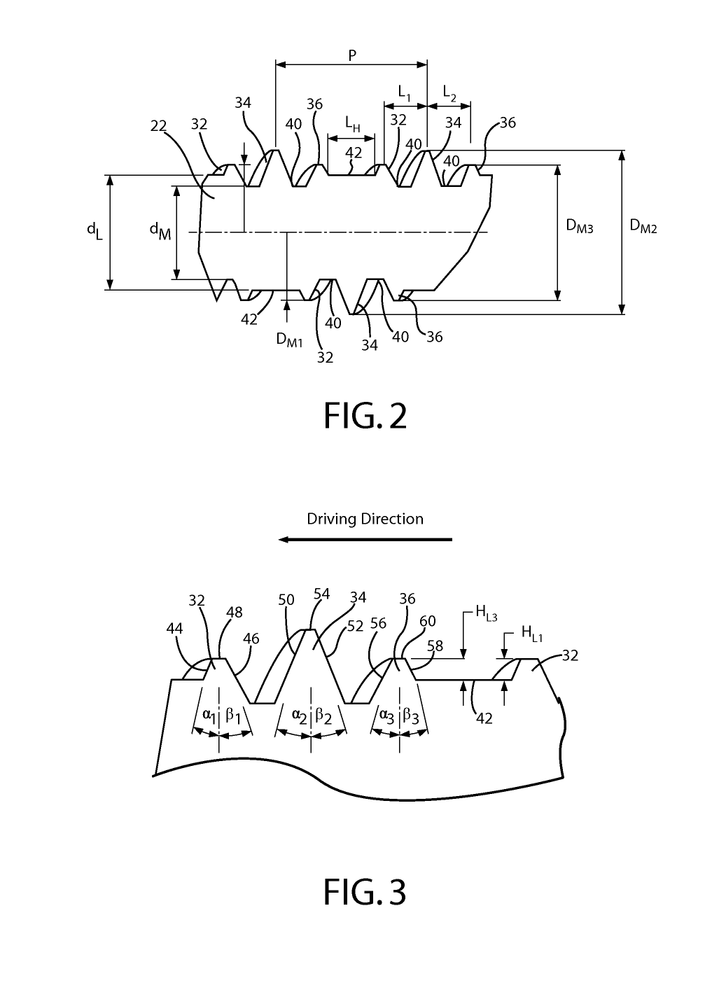

Referring now to FIGS. 1 and 2, a threaded fastener 20 for use in materials such as concrete, masonry and brick, as well as stone materials, composite materials, wood, or other materials. The threaded fastener 20 includes an elongated shank 22 having a threaded portion 24 along at least a portion of the shank 22, a pilot end 26 adapted to guide fastener entry, and a head 28. The thread forming fastener includes a first thread 32, a second thread 34, and a third thread 36 disposed helically about the shank 22. The threaded fastener includes grooves 40 on either side of the second thread 34 adapted to accommodate chips of material from the material the screw is threading into during fastening.

The first thread 32, the second thread 34 and the third thread 36 form a helical arrangement about the shank 22. As shown in FIG. 2, a helical land 42 may be provided axially extending between the third thread and adjacent first thread, such that the helical arrangement includes the first thread 32, the second thread 34, the third thread 36, and the helical land 42 disposed helically about the shank at a desired pitch P. As shown in FIG. 2, the first thread 32, the second thread 34 and the third thread 36 may have substantially the same thread pitch P.

The helical land 42 may have an axial land width L_{H} between the third thread and adjacent first thread. The axial land width L_{H} may be between about 15% and 45% of the thread pitch P. In one application, the helical land 42 may have an axial land width L_{H} greater than or equal to 25% of the thread pitch P. Alternatively, the axial land width L_{H} is greater than or equal to 30% of the thread pitch. In yet another alternative, the axial land width L_{H} is greater than or equal to 35% of the thread pitch P.

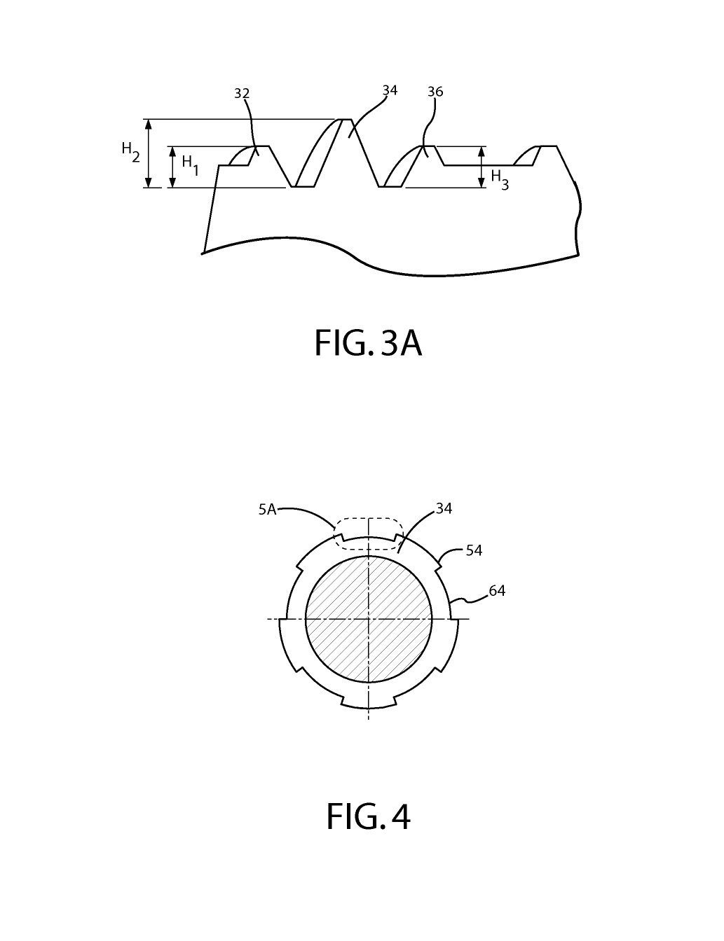

The helical land 42 may have an outside diameter d_{L} greater than the minor diameter dₘ and less than the major diameter D_{M1}, D_{M3} of the first thread and third thread, as shown in FIG. 2. The helical land may have a diameter d_{L} greater than a diameter at 40% of the thread height of the first thread 32. Alternatively, the helical land may have a diameter d_{L} greater than a diameter at 55% of the thread height of the first thread 32. As shown in FIG. 3, the first thread 32 may extend a height H_{L1} above the helical land 42, and the third thread 36 may extend a height H_{L3} above the helical land 42.

A shown in FIG. 3, the first thread 32 includes a first leading flank 44 and a first trailing flank 46, and a first thread tip 48, or the major diameter portion 48 at the outer portion of the first thread. The thread tip 48 is formed between an end of the leading flank 44 and an end of the trailing flank 46 defining the first thread major diameter D_{M1}, shown in FIG. 2. The second thread 34 includes a second leading flank 50 and a second trailing flank 52, and a second thread tip 54, or the major diameter portion 54 at the outer portion of the second thread. The thread tip 54 is formed between an end of the leading flank 50 and an end of the trailing flank 52 defining the second thread major diameter D_{M2}, shown in FIG. 2. The third thread 36 includes a third leading flank 56 and a third trailing flank 58, and a third thread tip 60, or the major diameter portion 60 at the outer portion of the third thread. The thread tip 60 is formed between an end of the leading flank 56 and an end of the trailing flank 58 defining the third thread major diameter D_{M3}, shown in FIG. 2. The major diameter portions 48, 54, 60 of the threads may have a shape selected from the group consisting of square shaped, rounded shaped, polygonal shaped, flat shaped, and pointed shaped. The shape of the major diameter portion of each of the first, second, and third threads may be the same shape. Alternatively, the shape of the major diameter portion of one thread may be different from the other two. In yet another alternative, the shape of the major diameter portion of each of the first, second, and third threads may be different.

As shown in FIGS. 1 and 2, the major diameter D_{M2} of the second thread 34 may be greater than the major diameter D_{M1} of the first thread 32, the major diameter D_{M3} of the third thread 36, or both the first thread major diameter D_{M1} and the third thread major diameter D_{M3}. In one application, the second thread 34 has a thread height H₂ between about 40% and 100% greater than at least one of the first thread height H₁ and the third thread height H₃, as shown in FIG. 3A. In certain embodiments, the major diameter D_{M1} of the first thread 32 may be greater than the major diameter D_{M2} of the second thread 34, the major diameter D_{M3} of the third thread 36, or both the second thread major diameter D_{M2} and the third thread major diameter D_{M3}. In yet another embodiment, the major diameter D_{M3} of the third thread 36 may be greater than the major diameter D_{M1} of the first thread 32, the major diameter D_{M2} of the second thread 34, or both the first thread major diameter D_{M1} and the second thread major diameter D_{M2}.

The first thread major diameter D_{M1} and the third thread major diameter D_{M3} may be substantially the same as shown in FIGS. 2 and 3. Alternatively, the third thread major diameter D_{M3} may be greater than the first thread major diameter D_{M1}, or the first thread major diameter D_{M1} may be greater than the third thread major diameter D_{M3}. At least one of the thread height of the first thread H₁ and the thread height of the third thread H₃ may be between about 45% and 85% of the second thread height H₂. Alternatively, at least one of the thread height of the first thread H₁ and the thread height of the third thread H₃ may be between about 50% and 70% of the thread height of the second thread H₂.

The depth of the grooves 40 may form the minor diameter dₘ of the fastener, the minor diameter dₘ being the smallest diameter of the thread form, shown in FIG. 2. In one alternative, the depth of the groove between the first thread and the second thread is different than the depth of the groove between the second thread and the third thread, the deeper groove being at the minor diameter dₘ of the fastener.

The second thread 34 may have notches 64 in the major diameter portion 54 of at least one turn of the second thread 34, as shown in FIG. 4. As shown in FIG. 1, the second thread 34 may include notches 64 in the major diameter portion 54 along the length of the threaded portion 24. Alternatively, the second thread 34 may include notches 64 in the major diameter portion 54 along at least a portion of the length of the thread. The notches 64 are adapted to engage the structure that the screw is threading into during fastening, such as concrete, masonry, brick, stone materials, composite materials, wood, or other materials.

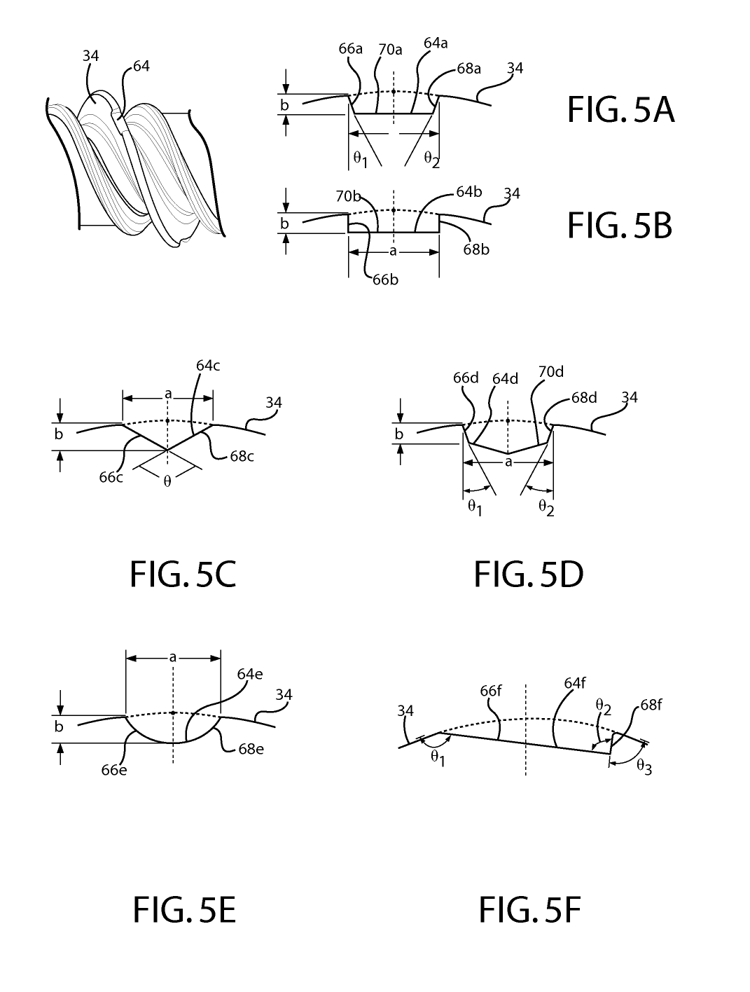

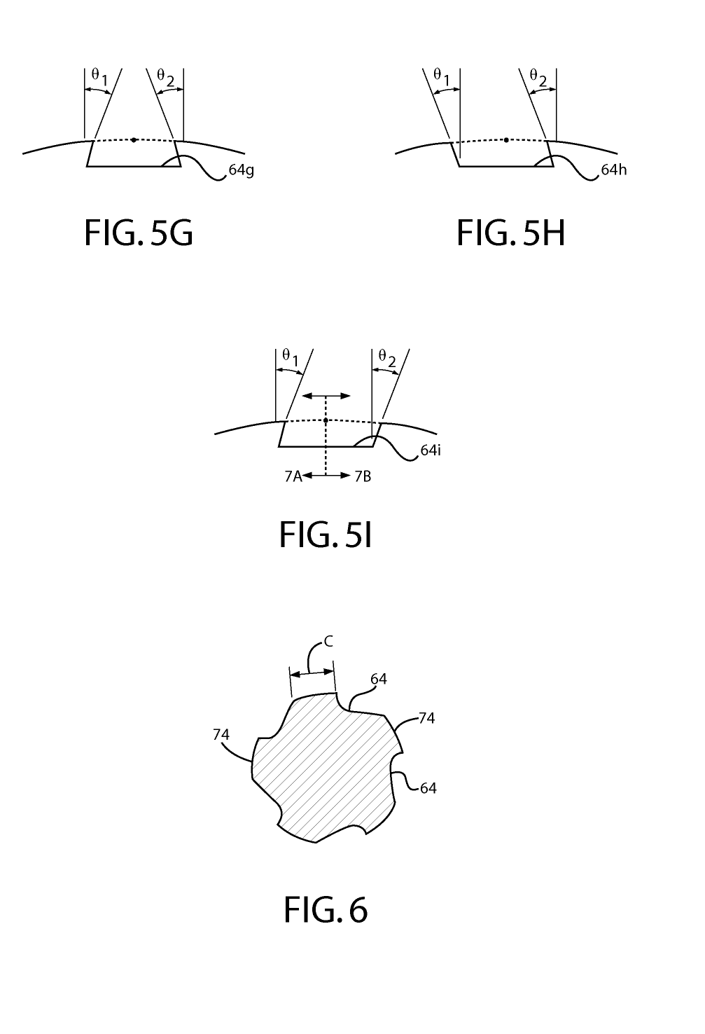

FIGS. 5A-5I show a sample of various examples of alternatives contemplated for the notches 64. Various forms of the notch 64 include a width “a” and a depth “b,” a leading notch surface 66 and a trailing notch surface 68. As the fastener rotates on installation of the fastener, the leading notch surface 66 follows the thread into the structure. However, edges of the trailing notch surfaces 68 are exposed to the material the fastener is threaded into as the fastener rotates. The edges of the trailing notch surfaces 68 aid in cutting of the material in which the fastener is being installed. Once the fastener is installed, the leading notch surface 66 may act to inhibit backing out of the fastener by edges of the leading notch surface and the leading notch surface 66 engaging the structure in the reverse rotating direction. The edges of the leading notch surface 66 and the trailing notch surface 68 may be sharp edges, or may be rounded, flattened, chamfered, or other shape as provided by the manufacturing process used to produce the notches 64. The notches 64 may have a width sized to form a lobular thread shape having a lobe 74 of an arc length “c” between two notches 64, one example shown in FIG. 6. The notches 64 may provide, for example, 5 lobes per thread revolution. Alternatively, notches may provide any suitable number of lobes as desired, such as from 3 lobes to 24 lobes, or more, per thread revolution.

The depth “b” of the notch 64 may be such that the diameter of the thread at the notch depth is approximately the same as or less than the major diameter D_{M1} of the first thread 32. Alternatively, the depth “b” of the notch 64 may be such that the diameter of the thread at the notch depth is approximately the same as or less than the major diameter D_{M3} of the third thread 36. In another alternative, the depth “b” of the notch 64 may be such that the diameter of the thread at the notch depth is any diameter as desired greater than or less than the first thread major diameter D_{M1} and/or the third thread major diameter D_{M3}.

The notch 64a as shown in FIG. 5A has forwardly tapered leading surface 66a at an angle θ₁ and rearwardly tapered trailing surfaces 68a at an angle θ₂, and a recessed surface 70a. The notch 64b as shown in FIG. 5B has approximately parallel leading surface 66b and trailing surfaces 68b that are approximately perpendicular to the recessed surface 70b. The notch 64c as shown in FIG. 5C is formed by the forwardly tapered leading surface 66c intersecting the rearwardly tapered trailing surfaces 68c at an angle θ. The notch 64d as shown in FIG. 5D has forwardly tapered leading surface 66d at an angle θ₁ and rearwardly tapered trailing surfaces 68d at an angle θ₂, and the recessed surface 70d having two portions forming an angle θ₃. The notch 64e as shown in FIG. 5E is formed by an concave arcuate leading surface 66e intersecting a concave arcuate trailing surfaces 68e forming an arcuate notch 64e. The notch 64f as shown in FIG. 5F is formed by the forwardly tapered leading surface 66f intersecting the rearwardly tapered trailing surfaces 68f at an angle θ₂, where the leading surface 66f is at an angle θ₁ to a line tangent the thread diameter and the trailing surface 68f is at an angle θ₃ to a second line tangent to the thread diameter, where θ₁ is different than θ₃.

FIGS. 5G-5I include variations of FIG. 5A, where the leading surface and trailing surfaces include various combinations of forwardly tapered and rearwardly tapered surfaces. For example, in FIG. 5G includes a rearwardly tapered leading surface 66g at an angle θ₁ and a forwardly tapered trailing surface 68g at an angle θ₂. It is contemplated that the configuration of FIG. 5G may be useful in hard structures with the trailing surface 68g providing improved thread cutting performance and the leading surface 66g providing increase back-out resistance. The configuration of FIG. 5H may be useful in a hard structure with improved cutting in the trailing surface 68h, and a forwardly tapered leading surface 66h for decreased resistance to fastener removal. Conversely, the configuration of FIG. 5I may provide improved installation in a softer structure with a rearwardly tapered trailing surface 68i, with improved back-out resistance with a rearwardly tapered leading surface 66i. The notch configurations shown in FIGS. 5A, 5D, and 5G-5I may include the leading angle θ₁ as defined in FIGS. 5A, 5D, and 5G-5I being approximately the same as the trailing angle θ₂ as defined in FIGS. 5A, 5D, and 5G-5I. Alternatively, the leading angle θ₁ may be greater than the trailing angle θ₂. In yet another alternative, the leading angle θ₁ is less than the trailing angle θ₂.

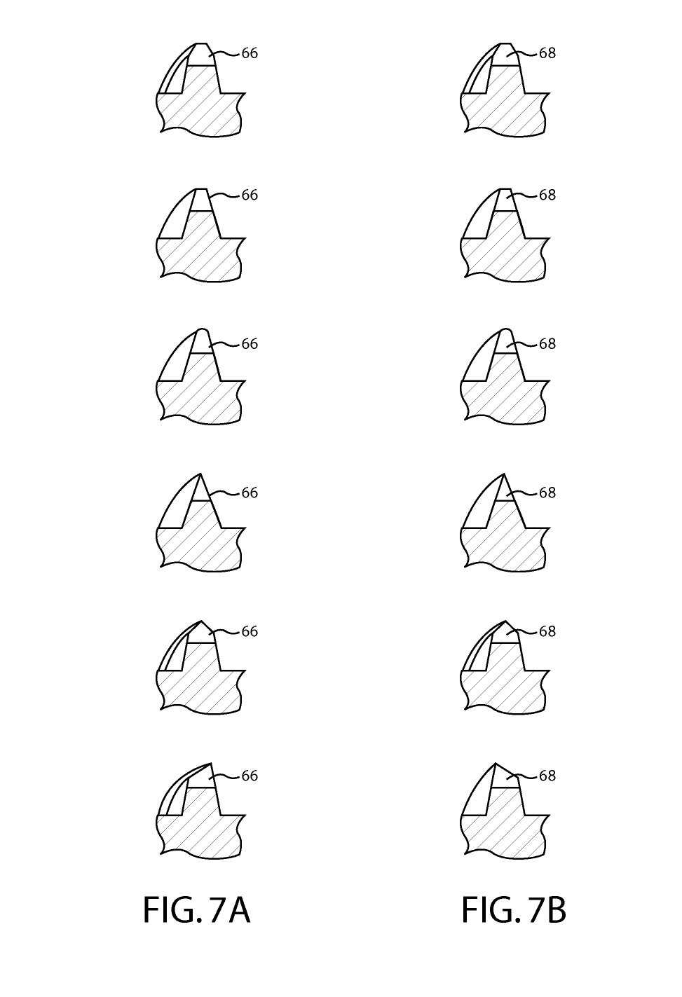

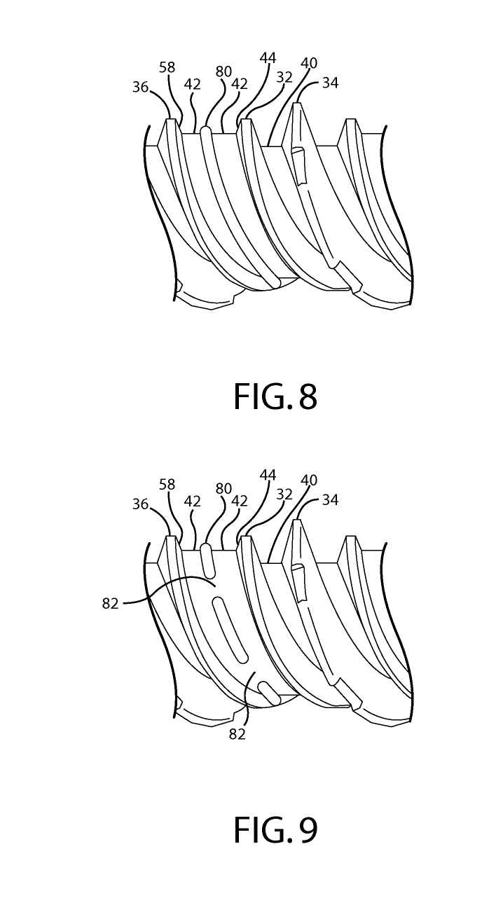

The leading notch surface 66 and the trailing notch surface 68 has a shape approximately the same as the cross-sectional shape of the thread, such as shown in FIGS. 7A and 7B. The leading notch surface 66 and the trailing notch surface 68 may be polygonal shape, triangular shape, arcuate shape, or another thread shape as desired formed by the shape of the leading flank and the trailing flank. Similarly, the leading flank and/or the trailing flank of the threads may be planar, arcuate, convex, concave, formed by two or more planes or arcuate surfaces, or any desired flank shape as desired.

For each thread, the leading flank angled toward the pilot end 26 defined in profile by an angle between the leading flank and a plane normal to the longitudinal axis of the fastener, or normal angles α₁, α₂, and α₃ as shown in FIG. 3 for the first thread 32, the second thread 34, and the third thread 36, respectively. The trailing flank is angled toward the head 28 defined in profile by an angle between the trailing flank and a plane normal to the longitudinal axis of the fastener, or normal angle β₁, β₂, and β₃ as shown in FIG. 3 for the first thread 32, the second thread 34, and the third thread 36, respectively. For the first thread 32, the normal angle α₁ of the leading flank 44 may be substantially the same as the normal angle β₁ of the trailing flank 46. Alternatively, the normal angle α₁ of the leading flank 44 of the first thread 32 may be greater than the normal angle 131 of the trailing flank 46. In one alternative, the normal angle α₁ of the leading flank 44 is between 1.2 and 2.5 times the normal angle β₁ of the trailing flank 46. In certain applications, the leading angle α₁ may be less than the trailing angle β₁. For the second thread 34, the normal angle α₂ of the leading flank 50 may be substantially the same as the normal angle β₂ of the trailing flank 52. Alternatively, the normal angle α₂ of the leading flank 50 of the second thread 34 may be greater than the normal angle β₂ of the trailing flank 52. In one alternative, the normal angle α₂ of the leading flank 50 is between 1.2 and 2.5 times the normal angle β₂ of the trailing flank 52. In certain applications, the leading angle α₂ may be less than the trailing angle β₂. For the third thread 36, the normal angle α₃ of the leading flank 56 may be substantially the same as the normal angle β₃ of the trailing flank 58. Alternatively, the normal angle α₃ of the leading flank 56 of the second thread 36 may be greater than the normal angle β₃ of the trailing flank 58. In one alternative, the normal angle α₃ of the leading flank 56 is between 1.2 and 2.5 times the normal angle β₃ of the trailing flank 58. In certain applications, the leading angle α₃ may be less than the trailing angle β₃.

The leading flank of each of the threads 32, 34, 36 may have a normal angle α between about 5° and 45°, and the trailing flank may have a normal angle β between about 5° and 45°. Alternatively, the leading flank may have a normal angle α between about 10° and 20°, and the trailing flank may have a normal angle β between about 10° and 20°. In one application, for each thread, the leading flank may have a normal angle α of 15° and the trailing flank may have a normal angle β of 15°.

The threaded fastener 20 may have at least one minor protrusion 80 formed along at least a portion of the helical land 42 positioned between the third thread 36 and adjacent first thread 32 as shown in FIG. 8. The minor protrusion 80 may be provided to improve the performance of the fastener under vibration. The minor protrusion 80 is not a thread form but a protrusion that may be provided to fill voids between the helical land 42 and the structure the fastener is threaded into increasing contact area between the thread portion 24 and the structure.

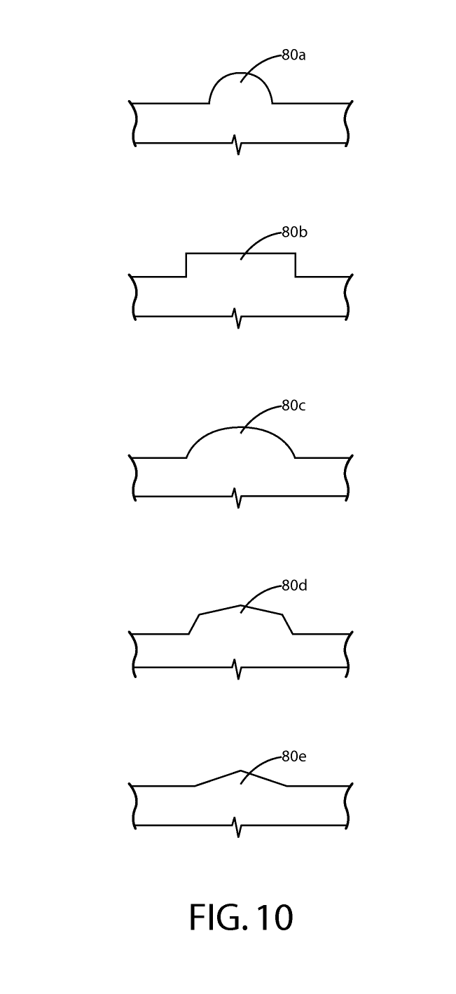

The minor protrusion 80 may be continuous along the helical land 42 positioned between the trailing flank 58 of the third thread 36 and the leading flank 44 of adjacent first thread 32 as shown in FIG. 8. Alternatively, the minor protrusion 80 may be intermittent along at least a portion of the helical land 42 by providing intermittent gaps 42 in the minor protrusion 80 as shown in FIG. 7. It is contemplated that the gaps 82 may further improve retention of the threaded fastener in the component as component material flows into the gaps 82 during installation. The height of the minor protrusion 80 may be not more than 40% of the height of the first thread and/or third thread over the helical land H_{L1}, H_{L3} (H_{L1}, H_{L3} shown in FIG. 3). Alternatively, the height of the minor protrusion 80 may be not more than 30% of the first and/or third thread height H_{L1}, H_{L3} over the helical land. As shown in FIG. 10, at least a part of the minor protrusion 80 may have a cross-sectional shape that is arcuate or semi-circular 80a, rectangular 80b, elliptical 80c, trapezoidal 80d, triangular 80e, or other non-thread shape that is desired. A lead side of the minor protrusion 80 may have a normal angle between 5° and 60° as desired.

The major diameter portions 48, 54, 60 of the first, second, and third threads, the thread tips, may have a flat surface, an angled surface, an arcuate surface, or other shape as desired. The major diameter portions may be tapered toward the leading flank, the trailing flank, or both, such as shown by alternative examples in FIG. 7A. One of the first thread, second thread, or third thread major diameter portion may be different from the others. Alternatively, the first thread, second thread, and third thread tips may be the same. In yet another alternative, the first thread, second thread, and third thread tips are all different from each other.

The presently disclosed fasteners may be made from low carbon steel, alloy steel, aluminum, brass, or other material as desired. The threaded fasteners may be made of a material selected as desired adapted to install into materials selected from concrete, masonry, brick, stone materials, composite materials, wood, or other materials.

The present fastener may be case hardened or through hardened. For certain applications, the masonry fasteners may be case hardened such that the outer surface of the fastener up to a depth between about 0.1 mm and about 0.5 mm is hardened to at least 45 Rockwell C Hardness scale (HRC) case hardness. In one alternative, depth of case hardness is between about 0.1 mm and 0.25 mm. For certain applications, the case hardness may be greater than 50 HRC. In one application, the case hardness is greater than 52 HRC. Alternatively, the present fastener may be through hardened. In a through hardened alternative, the through hardness may be between about 30 HRC and about 40 HRC. Alternatively, the through hardness may be between about 33 HRC and about 39 HRC.

Experimental samples of the present invention were tested and compared to prior masonry fasteners in the market. The tests were conducted by installing each sample fastener into a pre-drilled hole in a red clay brick, and then measuring the pull-out force. During the pull-out test, the test bricks experienced four failure modes, recorded in Table 1, below: Failure Mode A identifies those tests where the screw pulled out of the brick without other significant brick damage. Failure Mode B identifies those tests where the brick split apart through the fastener hole releasing the fastener. Failure Mode C identifies those tests where a portion of the top of the brick surrounding the fastener broke free as the fastener pulled out. Failure Mode D identifies those tests where the screw broke leaving a portion of the fastener in the brick.

TABLE 1
Pull-Out Force (Kgf) and Failure Mode in Brick

| | Screw | | | | | | |
|---|---|---|---|---|---|---|---|
| | Outside | Pull Out Force (Kgf) | | | | | |
| | Dia. | 1 | 2 | 3 | 4 | 5 | Average |
| Competitive | 5.28 mm | 652 | 479 | 651 | 537 | 637 | 591 |
| Sample #1 | M4 × 50 | A | A | A | A | A | |
| Present | 5.29 mm | 769 | 934 | 877 | 839 | 938 | 871 |
| Invention | | | | | | | |
| Case | M4 × 50 | B | A | A | A | D | |
| Hardened | | | | | | | |
| Present | 5.29 mm | 953 | 666 | 728 | 729 | 674 | 750 |
| Invention | | | | | | | |
| Thru | M4 × 50 | D | C | B | B | B | |
| Hardened | | | | | | | |
| Competitive | 5.18 mm | 933 | 722 | 550 | 911 | 685 | 760 |
| Sample #2 | 3/16 × 2 (in) | A | B | B | D | A | |

As shown in Table 1, when the present fastener was case-hardened, the pull-out force was significantly higher with less variation than the competitive samples. The case-hardened samples may have increased ductility in the center of the fastener over the through-hardened samples. Even though, the through-hardened samples of the present invention provided similar average pull out as competitive sample #2.

In further testing, additional experimental samples of the present invention were compared to competitive samples by installing each sample fastener into a pre-drilled hole in concrete, and then measuring the pull-out force. The concrete used in the test of TABLE 2 had a compressive strength of 27.58 MPa (4,000 psi). For some of the pull-out test samples, the screw broke leaving a portion of the fastener in the concrete. The test samples where the screw broke are marked in TABLE 2 by an asterisk (*). The remainder of the test samples failed by the screw pulling out of the concrete without other significant concrete damage.

TABLE 2
Pull-Out Force (Kgf) and Failure Mode in Concrete

| | Present | Present | | |
|---|---|---|---|---|
| | Invention | Invention | | Competitive |
| Sample | Case | Through | Competitive | Sample #2 |
| Fastener | Hardened | Hardened | Sample #1 | 3/16 × 2¼ |
| Size | M4 × 50 | M4 × 50 | M4 × 50 | (in) |
| 1 | 904.3 | 780.9 | 330.4 | 905.6 |
| 2 | 839.6 | 763.9 | 642.2 | 947.4 |
| 3 | 742.2 | 712.6 | 461.3 | 997.0* |
| 4 | 928.2 | 645.8 | 735.7 | 989.9* |
| 5 | 980.3* | 700.7 | 683.0 | 973.4* |
| 6 | 947.4* | 865.3 | 517.1 | 730.6 |
| 7 | 875.4 | 870.6 | 378.4 | 690.3 |
| 8 | 761.9 | 981.8* | 546.0 | 586.7 |
| 9 | 936.7 | 820.5 | 501.3 | 747.8 |
| 10 | 796.9 | 791.1 | 462.1 | 768.7 |
| 11 | 645.0 | 903.0 | 529.0 | 651.3 |
| 12 | 922.4 | 747.9 | 463.6 | 770.9 |
| 13 | 867.7 | 650.9 | 433.3 | 970.1 |
| 14 | 852.6 | 959.8* | 741.2 | 904.4 |
| 15 | 964.0 | 837.2 | 554.0 | 933.7* |
| 16 | 743.7 | 956.1 | 554.8 | 935.7* |
| 17 | 642.5 | 898.7 | 391.5 | 544.5 |
| 18 | 840.0 | 847.7 | 583.7 | 832.7 |
| 19 | 835.5 | 909.7 | 406.2 | 626.1 |
| 20 | 872.4 | 752.8 | 505.3 | 858.2 |
| 21 | 875.0 | 820.9 | 483.2 | 661.1 |
| 22 | 833.3 | 929.9 | 414.8 | 951.9* |
| 23 | 853.9 | 960.1 | 405.6 | 620.1 |
| 24 | 769.2 | 832.0 | 586.1 | 673.6 |
| 25 | 880.1 | 755.6 | 577.1 | 678.1 |
| 26 | 883.6 | 737.8 | 461.6 | 762.6 |
| 27 | 772.0 | 619.5 | 588.5 | 884.7 |
| 28 | 740.2 | 916.8 | 501.8 | 690.1 |
| 29 | 757.0 | 683.8 | 631.3 | 683.4 |
| 30 | 956.4* | 786.5 | 538.5 | 729.1 |
| AVERAGE | 840.6 Kgf | 814.6 Kgf | 520.3 Kgf | 790.0 Kgf |

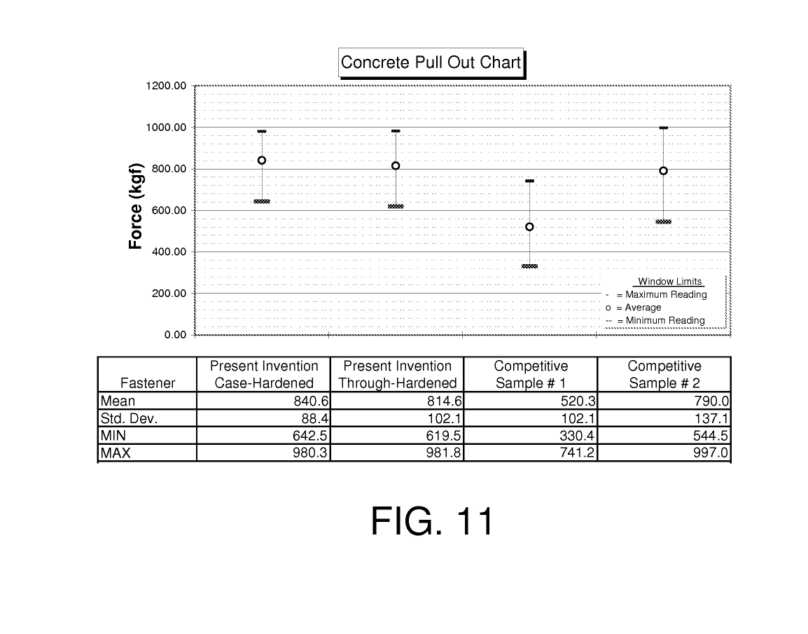

As shown in TABLE 2 and FIG. 11, both the case-hardened and through-hardened samples of the present invention provided higher average pull out force than the competitive samples with the same or less variation.

While the invention has been illustrated and described in detail in the drawings and foregoing description, the same is to be considered as illustrative and not restrictive in character, it being understood that only preferred embodiments have been shown and described and that all changes and modifications that come within the spirit of the invention are desired to be protected by the appended claims and the equivalents thereof.

What is claimed is:

1. A thread forming fastener for use in concrete, masonry, brick, and the like, comprising
a first thread, second thread, and third thread in a helical arrangement about a shank, each thread having substantially the same thread pitch,
the second thread having a major diameter greater than the major diameter of at least one of the first and third threads with grooves on either side of the second thread adapted to accommodate chips of material during fastening, and the second thread having notches in the major diameter of at least one turn adapted to engage at least one of concrete, masonry, and brick,
a helical land axially extending between the third thread and adjacent first thread having an outside diameter greater than the minor diameter and less than the major diameter of the first thread and third thread, the axial land width between the third thread and adjacent first thread being at least 25% of the thread pitch, and
having a pilot end adapted to guide fastener entry.

2. The thread forming fastener for use in concrete, masonry, brick, and the like as claimed in claim 1, where
the major diameter of the second thread has a shape selected from the group consisting of square shaped, rounded shaped, polygonal shaped, flat shaped, pointed shaped.

3. The thread forming fastener for use in concrete, masonry, brick, and the like as claimed in claim 1, where
the thread height of the second thread is between 40% and 100% greater than the thread height of at least one of the first and third threads.

4. The thread forming fastener for use in concrete, masonry, brick, and the like as claimed in claim 1, where
the major diameter of the first thread and the third thread are substantially the same.

5. The thread forming fastener for use in concrete, masonry, brick, and the like as claimed in claim 1, where
the thread height of the first thread and the third thread is between 45% and 85% of the thread height of the second thread.

6. The thread forming fastener for use in concrete, masonry, brick, and the like as claimed in claim 1, where
the thread height of the first thread and the third thread are between 50% and 70% of the thread height of the second thread.

7. The thread forming fastener for use in concrete, masonry, brick, and the like as claimed in claim 1, where
the major diameter of the third thread being greater than the major diameter of the first thread.

8. The thread forming fastener for use in concrete, masonry, brick, and the like as claimed in claim 1, where
the notches in the second thread have a shape selected from the group consisting of rectangular, triangular, polygonal, and arcuate.

9. The thread forming fastener for use in concrete, masonry, brick, and the like as claimed in claim 1, where
the notches extending a depth into the second thread less than 50% of the thread height.

10. The thread forming fastener for use in concrete, masonry, brick, and the like as claimed in claim 1, where the notches in the second thread form a series of lobes with the notches between the lobes about the rotational axis, each lobe having a leading portion and a tailing portion, the leading portion and first adjacent notch at a first angle in a range from 50° to 100° from a plane tangent to the lobe adjacent the leading portion, and the tailing portion and second adjacent notch at a second angle in a range from 25° to 50° from a plane tangent to the lobe adjacent the tailing portion, where the first angle is greater than the second angle.

11. The thread forming fastener for use in concrete, masonry, brick, and the like as claimed in claim 10, where the notches are positioned to form from 3 to 8 lobes about the diameter of the second thread.

12. The thread forming fastener for use in concrete, masonry, brick, and the like as claimed in claim 1, where
the axial land width is at least 35% of the thread pitch.

13. The thread forming fastener for use in concrete, masonry, brick, and the like as claimed in claim 1, where
the axial distance between the first thread and the second thread is substantially the same as the axial distance between the second thread and the third thread.

14. The thread forming fastener for use in concrete, masonry, brick, and the like as claimed in claim 1, where
the helical land axially extending between the third thread and adjacent first thread has a diameter greater than a diameter at 40% of the thread height of the first thread.

15. The thread forming fastener for use in concrete, masonry, brick, and the like as claimed in claim 1, where
the helical land axially extending between the third thread and adjacent first thread has a diameter greater than a diameter at 55% of the thread height of the first thread.

16. The thread forming fastener for use in concrete, masonry, brick, and the like as claimed in claim 1 having at least one minor protrusion formed along at least a portion of the helical land.

17. The thread forming fastener for use in concrete, masonry, brick, and the like as claimed in claim 16 where the minor protrusion is continuous along the helical land.

18. The thread forming fastener for use in concrete, masonry, brick, and the like as claimed in claim 16 where the minor protrusion is intermittent along the helical land.

19. The thread forming fastener for use in concrete, masonry, brick, and the like as claimed in claim 16 where the minor protrusion has an outer diameter not more than the major diameter of the first thread.

20. The thread forming fastener for use in concrete, masonry, brick, and the like as claimed in claim 16 where the minor protrusion has an outer diameter not more than the major diameter of the second thread.

21. The thread forming fastener for use in concrete, masonry, brick, and the like as claimed in claim 16 where the minor protrusion has a cross-sectional shape selected from the group consisting of arcuate, rectangular, elliptical, trapezoidal, and triangular.

22. The thread forming fastener for use in concrete, masonry, brick, and the like as claimed in claim 16 where a lead side of the minor protrusion may have a normal angle between about 10° and 60°.

23. A thread forming fastener for use in concrete, masonry, or the like, comprising
a first thread, second thread, and third thread in a helical arrangement about a shank, each thread having approximately the same thread pitch,
the major diameter of the second thread being greater than the major diameter of at least one of the first and third threads.

24. The thread forming fastener for use in concrete, masonry, brick, and the like as claimed in claim 23, where
the major diameter of the second thread has a shape selected from the group consisting of square shaped, rounded shape, polygonal shape, flat shape, pointed shape.

25. The thread forming fastener for use in concrete, masonry, brick, and the like as claimed in claim 23, where
the thread height of the second thread is between 40% and 100% greater than the thread height of at least one of the first and third threads.

26. The thread forming fastener for use in concrete, masonry, brick, and the like as claimed in claim 23, where
the major diameter of the first thread and the third thread are substantially the same.

27. The thread forming fastener for use in concrete, masonry, brick, and the like as claimed in claim 23, where
the thread height of the first thread and the third thread is between 45% and 85% of the thread height of the second thread.

28. The thread forming fastener for use in concrete, masonry, brick, and the like as claimed in claim 23, where
the thread height of the first thread and the third thread are between 50% and 70% of the thread height of the second thread.

29. The thread forming fastener for use in concrete, masonry, brick, and the like as claimed in claim 23, where
the major diameter of the third thread being greater than the major diameter of the first thread.

30. The thread forming fastener for use in concrete, masonry, brick, and the like as claimed in claim 23, where
the axial distance between the first thread and the second thread is substantially the same as the axial distance between the second thread and the third thread.

31. The thread forming fastener for use in concrete, masonry, brick, and the like as claimed in claim 23, further comprising:
a helical land axially extending between the third thread and adjacent first thread having an outside diameter greater than the minor diameter and less than the major diameter of the first thread and third thread, the axial land width between the third thread and adjacent first thread being at least 25% of the thread pitch.

32. The thread forming fastener for use in concrete, masonry, brick, and the like as claimed in claim 31,
the helical land axially extending between the third thread and adjacent first thread having a diameter greater than a diameter at 40% of the thread height of the first thread.

33. The thread forming fastener for use in concrete, masonry, brick, and the like as claimed in claim 31,
the helical land axially extending between the third thread and adjacent first thread having a diameter greater than a diameter at 55% of the thread height of the first thread.

34. The thread forming fastener for use in concrete, masonry, brick, and the like as claimed in claim 31, where
the axial land width is at least 35% of the thread pitch.

35. The thread forming fastener for use in concrete, masonry, brick, and the like as claimed in claim 31 having at least one minor protrusion formed along at least a portion of the helical land.

36. The thread forming fastener for use in concrete, masonry, brick, and the like as claimed in claim 35 where the minor protrusion is continuous along the helical land.

37. The thread forming fastener for use in concrete, masonry, brick, and the like as claimed in claim 35 where the minor protrusion is intermittent along the helical land.

38. The thread forming fastener for use in concrete, masonry, brick, and the like as claimed in claim 35 where the minor protrusion has an outer diameter not more than the major diameter of the first thread.

39. The thread forming fastener for use in concrete, masonry, brick, and the like as claimed in claim 35 where the minor protrusion has an outer diameter not more than the major diameter of the second thread.

40. The thread forming fastener for use in concrete, masonry, brick, and the like as claimed in claim 35 where the minor protrusion has a cross-sectional shape selected from the group consisting of arcuate, rectangular, elliptical, trapezoidal, and triangular.

41. The thread forming fastener for use in concrete, masonry, brick, and the like as claimed in claim 35 where a lead side of the minor protrusion may have a normal angle between about 10° and 60°.
